(19) United States
(12) Patent Application Publication
(10) Pub. No.: US 2017/0010346 A1
(43) Pub. Date: Jan. 12, 2017

(54) TEST BENCH FOR TESTING A DISTANCE RADAR INSTRUMENT FOR DETERMINING DISTANCE AND SPEED OF OBSTACLES

(71) Applicant: dSPACE digital signal processing and control engineering GmbH, Paderborn (DE)

(72) Inventors: Andre Rolfsmeier, Bad Lippspringe (DE); Frank Schütte, Warburg (DE); Albrecht Lohöfener, Paderborn (DE); Carsten Grascher, Paderborn (DE); Michael Rozmann, Eichenau (DE)

(21) Appl. No.: 15/204,305

(22) Filed: Jul. 7, 2016

(30) Foreign Application Priority Data
Jul. 8, 2015 (DE) 102015111014.8
Jul. 6, 2016 (EP) 16178215.6

(51) Int. Cl. G01S 7/40

(52) U.S. Cl. CPC G01S 7/4052; G01S 2007/4082

(57) ABSTRACT

A test bench for testing a distance radar instrument for determining distance and speed of obstacles, comprising a radar emulation device comprising at least one radar antenna and a computer unit with a model of the surroundings, wherein the model of the surroundings comprises data (x, v) of at least one obstacle with a relative position and speed from the distance radar instrument, wherein the radar emulation device emits a suitable reflection radar signal on the basis of the relative position and speed predetermined by the model of the surroundings at least partly in the direction of the distance radar instrument after receiving a scanning radar signal from the distance radar instrument such that the distance radar instrument detects an obstacle with a predetermined relative position and speed, wherein the radar emulation device extends over an angular range in front of the distance radar instrument such that the obstacle with relative position and speed can be simulated in this angular range with mutually distinguishable angles.

### CROSS REFERENCE TO RELATED APPLICATIONS

This application claims the benefit of German patent application no. DE102015111014.8, filed on Jul. 8, 2015; and European patent application no. EP16178215.6, filed on Jun. 6, 2016. This application is related to the co-pending commonly assigned United States non-provisional application titled “TEST BENCH FOR TESTING A DISTANCE RADAR INSTRUMENT FOR DETERMINING DISTANCE AND SPEED OF OBSTACLES”, with application number ______. The entire contents of all are hereby incorporated by reference in its entirety.

### BACKGROUND OF THE INVENTION

Typical distance radar instruments comprise one or more radar antennas, a logic unit for measuring and evaluating detected radar signals and interfaces to other control instruments of the vehicle. The radar instrument transmits suitable electromagnetic waves in the radio-frequency range—in this case as a scanning radio signal—into a specific direction of the surroundings thereof and waits for a reflected echo signal—the reflection radar signal. The generation of such radio waves is sufficiently well known; exemplary methods include frequency modulated continuous wave radar and pulse compression based methods. These systems are used to produce and receive a radar signal reflected at an obstacle, which allows conclusions to be drawn about the relative position and speed of the object and the receiver. This is typically done by evaluating the time-of-flight of the pulse and the frequency shift (Doppler effect). The scanning radar instrument scans its surroundings over angular steps and thus obtains spatially resolved information about position and speed of the surrounding obstacles within the scanned area. Distance radar instruments can be installed on a vehicle's exterior, e.g. in the radiator hood, or within the vehicle, e.g. in the upper part of the windshield.

Emulation devices exist to test radar distance instruments. Known emulation devices comprise a radar antenna that receives the scanning radar signal from a distance radar instrument under test. In response to the received signal, the emulation device generates a simulated reflection radar signal, based on a predetermined relative position and speed data. The simulated reflection radar signal is received by the radar instrument under test, which interprets the signal to identify a simulated obstacle using the predetermined relative position and speed data. Such an exemplary device is described, for example, in the product brochure of the ARTS9510 by Rohde&Schwarz (retrievable from https://www.rohde-schwarz.com/en/product/arts9510-productstartpage_63493-114114.html, retrieved 2015).

These radar emulation devices known from the prior art and test benches using such radar emulation devices are not suitable for representing situations of the surroundings in a realistic way.

### BRIEF SUMMARY OF THE INVENTION

It is an object of the present disclosure to describe the test benches that provide realistic situations of the surroundings. Test benches are often used to test individual components from motor vehicles and control devices of motor vehicles in the laboratory under real physical conditions. To this end, the data and measurement values, which the component to be tested requires, are calculated by means of a suitable model of the remaining vehicle and the surroundings thereof—the model of the surroundings in this case—and converted into real physical variables by methods known in the art.

The inventions of the present disclosure are based on the discovery that the detection of three-dimensional, extended objects is required when testing a distance radar instrument in complex test scenarios with a three-dimensional model of the surroundings in order to be able to make a realistic assessment of the functionality of the distance radar instrument to be tested.

The disclosed inventions relate to a test bench for testing a distance radar instrument for determining distance and speed of obstacles, comprising a radar emulation device comprising at least one radar antenna and a computer unit with a model of the surroundings, wherein the model of the surroundings comprises data of at least one obstacle with a relative position and speed from the distance radar instrument, wherein the radar emulation device emits a suitable reflection radar signal on the basis of the relative position and speed predetermined by the model of the surroundings at least partly in the direction of the distance radar instrument after receiving a scanning radar signal from the distance radar instrument such that the distance radar instrument detects an obstacle with a predetermined relative position and speed.

In conjunction with the disclosed inventions, a model of the surroundings is understood to be a surroundings model, in which the vehicle model, which is connected to the component to be tested, moves and with which it interacts. By way of example, the model of the surroundings is a three-dimensional representation of a road network with a virtual test track, and moreover comprises additional movable road users (e.g., vehicles, pedestrians) and non-moving objects such as guardrails, other obstacles and the like. However, in the simplest form thereof, the model of the surroundings can comprise a single vehicle and define the relative speed and position thereof.

In the disclosed inventions, a distance radar instrument is understood to mean an electronic control instrument comprising at least one radar antenna for transmitting and receiving radar signals, for installation into a motor vehicle. By way of example, such distance radar instruments are used to obtain measurement data from the vehicle surroundings for an automatic emergency brake (AEB), for an adaptive cruise control (ACC) and for lane change support (LCS). These safety-relevant automatic controls require real-time information about the position and speed of approaching obstacles such as e.g. road users or stationary objects in the vehicle surroundings in order to be able to intervene into the vehicle guidance in good time and in order to avoid collisions.

In accordance with the subject matter of the invention, a test bench for testing a distance radar instrument for determining distance and speed of obstacles is proposed, comprising a radar emulation device comprising at least one radar antenna and a computer unit with a model of the surroundings, wherein the model of the surroundings comprises data of at least one obstacle with a relative position and speed from the distance radar instrument, wherein the radar emulation device emits a suitable reflection radar signal on the basis of the relative position and speed predetermined by the model of the surroundings at least partly in the direction of the distance radar instrument after receiving a scanning radar signal from the distance radar instrument such that the distance radar instrument detects an obstacle with a predetermined relative position and speed.

The test bench according to the disclosed system includes a radar emulation device that extends over an angular range in front of the distance radar instrument such that the obstacle with relative position and speed can be simulated in this angular range with mutually distinguishable angles.

In a first embodiment, the test bench is configured in such a way that the radar emulation device comprises a positioning system for moving the radar antenna over the angular range such that the obstacle can be simulated with predetermined relative position and speed in this angular range. By way of example, such a positioning system can be implemented by way of a suitable rail system, on which one or more radar antennas are attached on in each case movable sleds. The movement of the sleds can be ensured by stepper or linear drives, which are actuatable by the computer unit.

In a further embodiment, the test bench is embodied in such a way that a radar antenna is brought into the position calculated by the model of the surroundings for each obstacle and the relative speed of the obstacle can be represented by the positioning system by the movement of the radar antenna. This embodiment offers the advantage of being able to represent the lateral velocity portion of e.g. an overtaking vehicle ahead of the distance radar instrument by the movement of the radar antenna and the radial portion by a suitable generation of the reflection radar signal.

A development ensures that each radar antenna is attached to the positioning system in such a way that it does not shadow any further radar antenna on the positioning system. Such shadowing may occur if, for example, two radar antennas are moved in opposite directions and cross one another. However, if the radar antenna which travels in the plane more distant in respect of the distance radar instrument is associated with an object lying closer to the simulated vehicle with a distance radar instrument, such shadowing by a radar antenna lying closer in respect of the distance radar instrument is unwanted.

In one embodiment, it is preferable for the shadowing of the radar antenna by a different one to be avoided by virtue of the radar antennas each being attached at a different level in relation to the movement direction of the positioning system.

In accordance with another development of the test bench, the positioning system is designed in such a way that the radar antennas are movably arranged on a common guide contour. In this development, the movement of the radar antennas is afflicted by collisions. Therefore, it is necessary to ensure that, if two antennas approach one another, these reverse their movement just before the point of collision and, moreover, transfer the obstacle to be simulated to the respectively other antenna.

In a development alternative thereto, the test bench is designed in such a way that the radar antennas are in each case movably arranged on separate guide contours. In this refinement, no collision of the movable radar antennas is possible.

In one development of the test bench, the positioning system is designed in such a way that the guide contours extend in a straight line, in particular parallel to one another in the view of the distance radar instrument. In this embodiment, it is necessary to include the time-of-flight difference of the externally situated radar antennas in comparison with the radar antennas situated on the inside when predetermining the relative position.

In another embodiment, the test bench has such an embodiment that the positioning system is designed in such a way that the guide contours extend in concave fashion with an opening toward the distance radar instrument. By way of example, it is advantageous for the radius of curvature of the guide contour and the distance between the distance radar instrument and the guide of the radar antennas to be selected in such a way that all radar antennas are positioned at the same distance from the distance radar instrument. In this case, no equalization of time-of-flight differences of the radar signal is necessary.

In one development, the test bench has such an embodiment that the radar antennas are arranged in such a rotatable manner that they are alignable onto the distance radar instrument in the case of movement. This configuration ensures that the externally situated radar antennas also reliably receive the strongly directional scanning radar signal and the distance radar instrument is able to reliably receive the reflection radar signals.

In a variant of the test bench according to the present disclosure which follows a completely different concept, provision is made for the radar emulation device to comprise a multiplicity of stationary radar antennas which are distributed over the angular range. In this embodiment, no movable components are provided in contrast to the solutions illustrated above.

In one development, the test bench has such a design that the azimuthal portion of the position of the simulated obstacle is set by the azimuthal position of the detecting radar antenna of the radar emulation device. Thus, if the object to be simulated moves in the azimuthal direction, there is a change in the radar antenna responsible for receiving the scanning radar signal.

In another embodiment of the test bench, the number of radar antennas is selected in such a way that a predetermined angular resolution is obtainable.

In one development, the test bench is designed in such a way that the multiplicity of radar antennas are arranged on a contour extending in a straight line.

In another embodiment, the test bench is designed in such a way that the radar antennas are arranged on a concave contour with an opening in the direction of the distance radar instrument.

In one development, the test bench is designed in such a way that a first radar antenna receives the scanning signal and a second radar antenna subsequently transmits the reflection radar signal. This is possible since the direction from which the reflection radar signal comes is of no consequence to the distance radar instrument. The identified azimuthal position of the reflecting obstacle will, to a good approximation, be the one corresponding to the angle of the emitted scanning radar signal.

In an alternative embodiment, the test bench is designed in such a way that the model of the surroundings comprises data about the material properties of the obstacle and the reflection radar signal emitted by the radar emulation device in the direction of the distance radar instrument is constituted in such a way that the radar emulation device detects the material properties of the simulated obstacle. This is based on the discovery that radar signals are reflected with different signal damping from materials with different material properties, e.g. metallic or wooden surfaces. In this alternative embodiment, this is used by virtue of known materials being associated with typical characteristic damping values and these being disclosed to the distance radar instrument. Then, the radar emulation device generates a suitable reflection radar signal with the characteristic damping fitting to the simulated material. The distance radar instrument then is able to deduce the material properties from the measured damping.

In a further variant of the test bench for testing a distance radar instrument for determining distance and speed of obstacles, the radar emulation device is connected to the distance radar instrument in a closed control loop in such a way that the obstacle can be simulated in real time; such a simulation design is also referred to as a hardware-in-the-loop simulation.

In an alternative embodiment of the test bench for testing a distance radar instrument for determining distance and speed of obstacles, the radar emulation device is designed in such a way that the scanning radar signal initially passes over at least one deflection mirror for mirroring radar waves prior to being detected by a radar antenna. Alternatively, or additionally, the reflection radar signal initially can pass over at least one deflection mirror for mirroring radar waves prior to being detected by the distance radar instrument. Here, an arrangement of a plurality of a stationary or movably attached mirrors is also conceivable, said mirrors being installed in such a way that the number of radar antennas in the radar emulation device can be reduced.

### BRIEF DESCRIPTION OF THE DRAWINGS

The invention is explained in more detail below with reference to the drawings. Here, equivalent parts are denoted by identical reference signs. The illustrated embodiments are highly schematic, i.e. the distances and the lateral and vertical extents are not true to scale and, provided nothing else is specified, they do not have any derivable geometric relations to one another either. In detail:

FIG. 1 is a schematic view of a first embodiment of a test bench according to the invention for testing a distance radar instrument for determining distance and speed of obstacles,

FIG. 2 is a schematic view of a test bench according to the invention in an embodiment comprising a positioning system for moving the radar antenna over the angular range,

FIG. 3 is a schematic view of a test bench according to the invention in an embodiment comprising radar antennas at different levels in a lateral view,

FIG. 4 is a schematic view of a test bench according to the invention in an embodiment comprising an arrangement of the radar antennas on separate guide contours,

FIG. 5 is a schematic view of a test bench according to the invention in an embodiment with an arrangement of the radar antennas on concave guide contours,

FIG. 6 is a schematic view of a test bench according to the invention in an embodiment comprising an arrangement of stationary radar antennas,

FIG. 7 is a schematic view of a test bench according to the invention in an embodiment comprising a positioning system for moving the radar antenna over an angular range and an exemplary illustration of the simulation of an overtaking maneuver, and

FIG. 8 is a schematic view of a test bench according to the invention in an embodiment comprising an arrangement of stationary radar antennas and an exemplary illustration of the simulation of an overtaking maneuver.

### DETAILED DESCRIPTION OF THE INVENTION

The following descriptions of the various embodiments are exemplary and not intended to limit the scope of the claimed inventions.

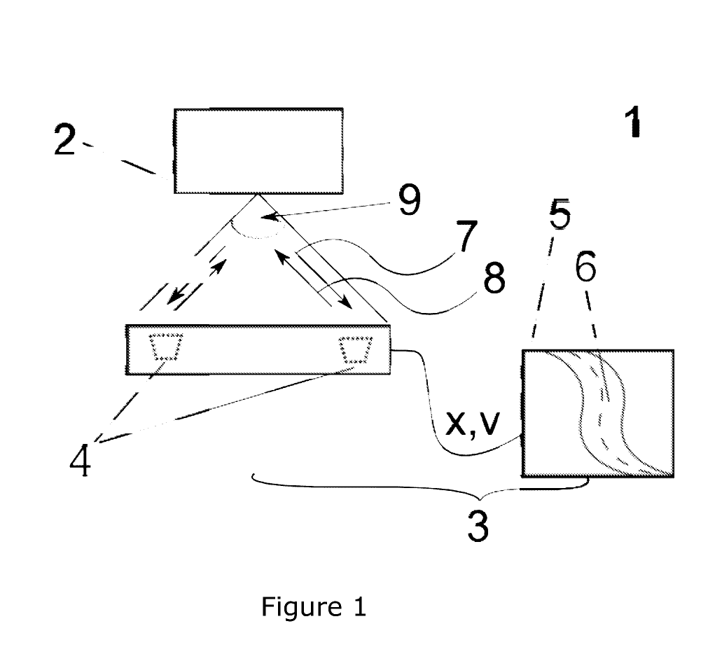

FIG. 1 shows the schematic illustration of a test bench 1 for testing a distance radar instrument 2 for determining distance and speed of obstacles. Shown is a radar emulation device 3, which comprises at least one radar antenna 4 and a computer unit 5 with a model of the surroundings 6. The model of the surroundings 6 is indicated by a stylized road, but it can contain movable road users such as vehicles and non-moving obstacles in addition to road surroundings. The model of the surroundings 6 provides data (x, v) for the relative position and speed of an obstacle in relation to the distance radar instrument 2. After receiving a scanning radar signal 7 emanating from the distance radar instrument 2, the radar emulation device 3 emits a suitable reflection radar signal 8 at least partly in the direction of the distance radar instrument 2 on the basis of the data (x, v). Said distance radar instrument 2 then detects an obstacle with the predetermined relative position and speed. Thus, the radar emulation device 3 extends over an angular range 9 in front of the distance radar instrument 2, which can also simulate a plurality of obstacles with relative position and speed in this angular range 9 with mutually distinguishable angles, or it is also possible to simulate an obstacle with lateral movement.

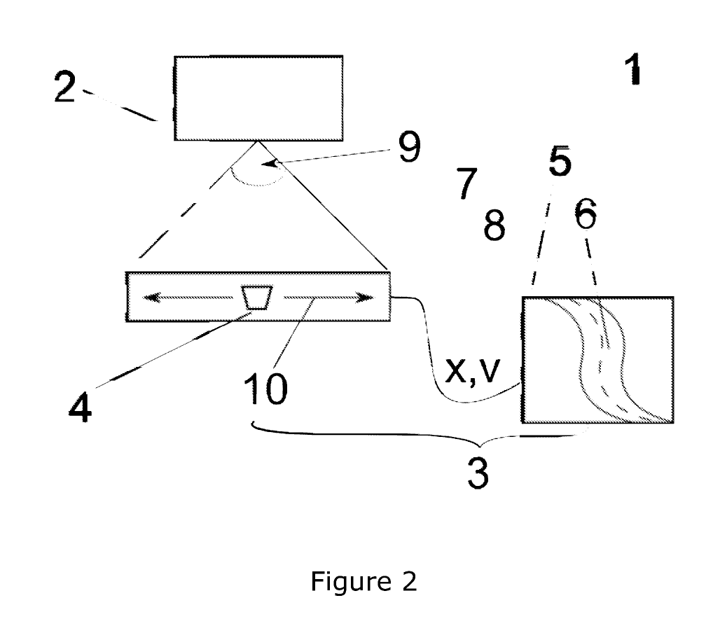

FIG. 2 shows the schematic illustration of a test bench 1 for testing a distance radar instrument 2 for determining distance and speed of obstacles, as is already described for FIG. 1. In this embodiment, the system comprises a positioning system 10, by means of which the radar antenna 4 can be moved over the angular range 9.

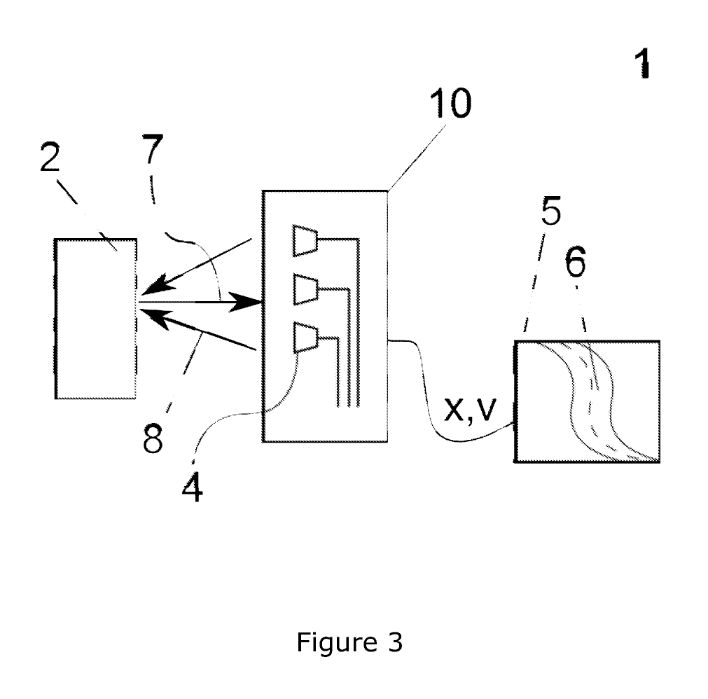

FIG. 3 depicts a lateral view of the test bench 1 for testing a distance radar instrument 2 for determining distance and speed of obstacles. In this embodiment, the radar antennas are situated on a positioning system 10, which is only indicated here by a box, wherein each one of the radar antennas 4 is guided at a different level in order to avoid the shadowing of one another.

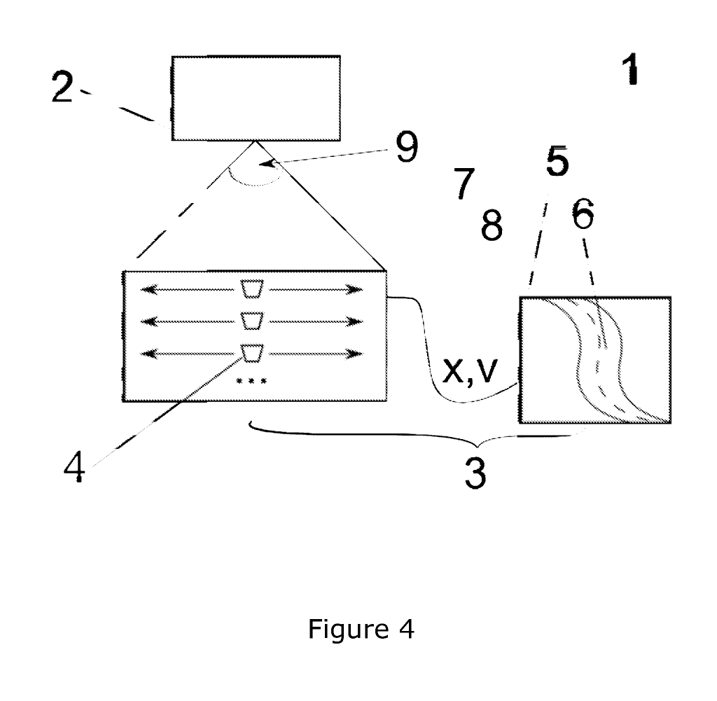

FIG. 4 shows a further embodiment of the test bench 1 for testing a distance radar instrument 2 for determining distance and speed of obstacles. Here, provision is made for the radar antennas 4, which are movably arranged on the positioning system 10, to be guided on separate guide contours. By way of example, a radar antenna 4 can be assigned to each obstacle to be simulated in this embodiment. It is then possible, on the guide contours, to reproduce the azimuthal portion of the movement of the obstacle to be simulated by the movement of the radar antenna 4 in the positioning system 10. To this end, the radar antennas 4 can be moved with the aid of e.g. a stepper motor. If shadowing of one or more of the radar antennas 4 is unwanted in the selected test scenario, it is possible to resort to radar antennas 4 guided at different levels, as described in FIG. 3.

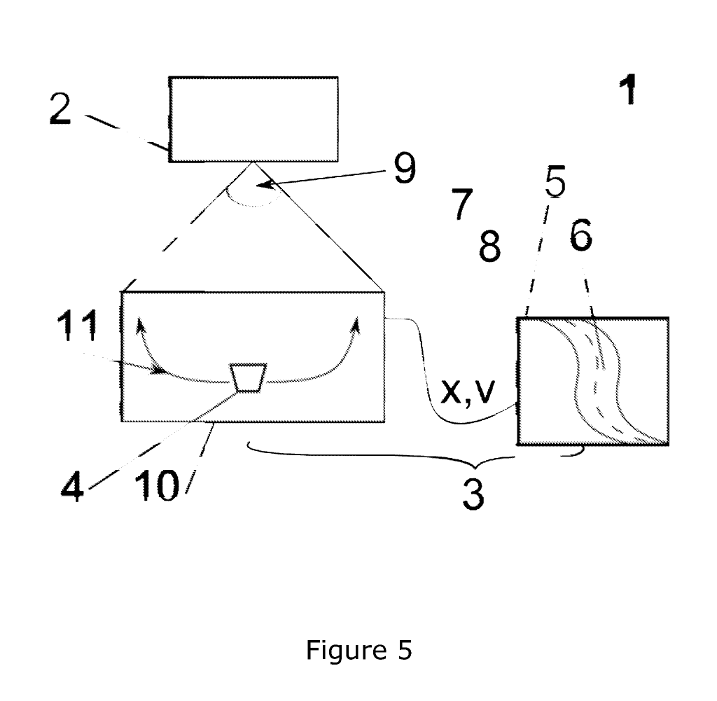

FIG. 5 shows a further embodiment of the test bench 1 for testing a distance radar instrument 2 for determining distance and speed of obstacles. This exemplary embodiment shows that the radar antennas 4 can be arranged on concave guide contours 11 by means of the positioning system 10. Here, the opening of the concave guide contour 11 is aligned onto the distance radar instrument 2. Thus, the appropriate selection of the distance between the distance radar instrument 2 and the positioning system 10 and the selection of the radius of curvature of the guide contours 11 allows an arrangement of the test bench to be created in which all radar antennas 4 have the same distance from the distance radar instrument 2.

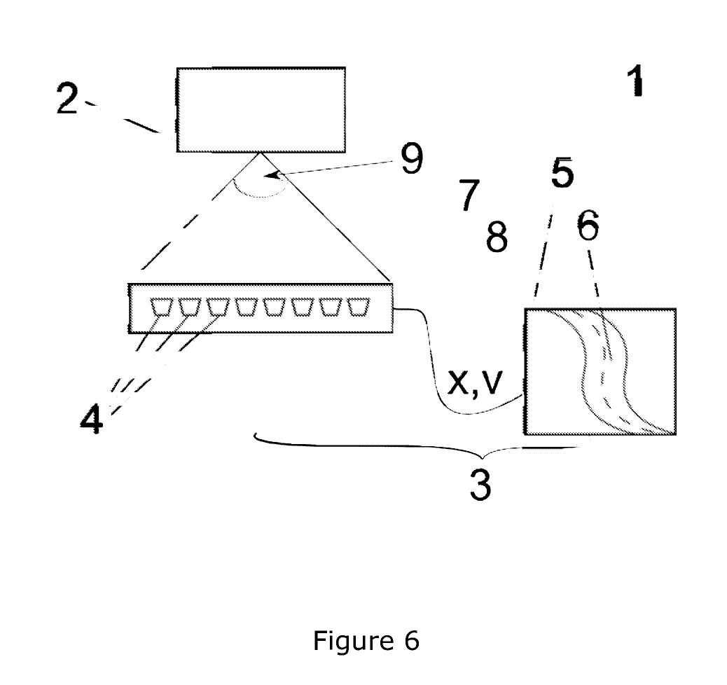

A further embodiment of the test bench 1 for testing a distance radar instrument 2 for determining distance and speed of obstacles is depicted in FIG. 6. In this embodiment, provision is made of arranging a plurality of stationary radar antennas 4. This arrangement covers the angular range 9 according to the invention. In this exemplary embodiment, provision is made for the obstacle to be simulated always to be represented by the stationary radar antenna 4 which is arranged in the angular portion in which the vehicle to be simulated is situated in respect of the distance radar instrument 2.

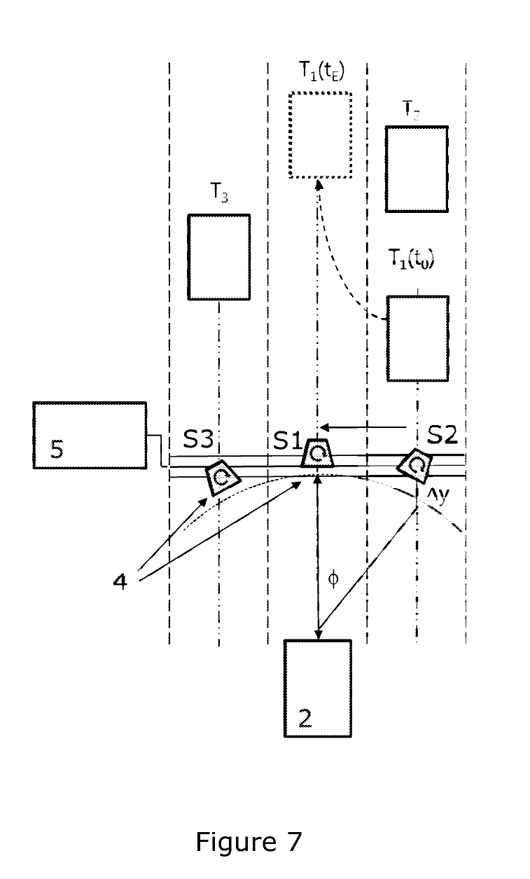

FIG. 7 shows an exemplary illustration of the test bench 1 for testing a distance radar instrument 2 for determining distance and speed of obstacles by illustrating an overtaking maneuver to be simulated with three involved vehicles T1, T2 and T3, which are all situated in front of the distance radar instrument 2 to be tested. The relative position and speed of the simulated vehicles is calculated by the radar emulation device 3. The results are indicated schematically above the arrangement of the radar antennas 4. The illustration shows an embodiment as already described in relation to FIGS. 2 and 3 and it comprises a positioning system 10, on which the radar antennas 4 are arranged in movable fashion. A radar antenna 4 is attached in front of the distance radar device 2 to be tested on the positioning system 10 for each vehicle T1, T2 and T3 to be simulated. In the simulated scenario, provision is made for vehicle T1 initially to be situated behind vehicle T2 at the time t₀ (denoted T1(t₀) in the drawing). At this time, the azimuthal portion of the position of the vehicle (corresponding to the angle φ) is represented by the azimuthal position of the associated radar antenna (denoted by S1). In the next step, T1 accelerates and moves past vehicle T2 in an overtaking manner with an azimuthal velocity component. This is indicated by the dashed arrow which represents the movement of the vehicle. The dashed representation T1 (t_{E}) indicates the position of the simulated vehicle at an instant during the overtaking maneuver. The azimuthal velocity component is depicted in this example by the movement of the radar antenna 4 (denoted by S1) associated with T1 in the direction of the arrow.

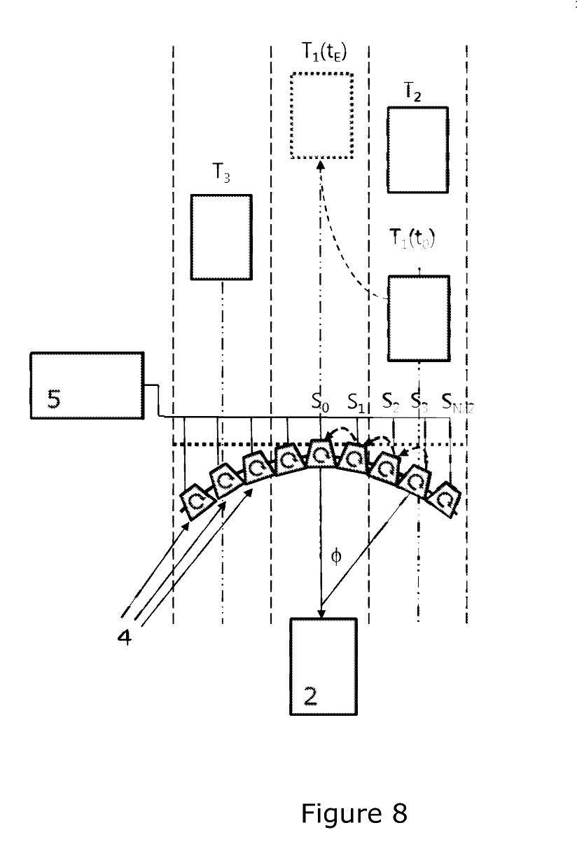

FIG. 8 shows the overtaking maneuver described as in FIG. 7. In this case, the depicted embodiment according to the invention is an arrangement of stationary radar antennas 4 on a guide contour which is open toward the distance radar instrument 2. In this example, each one of the three vehicles T1, T2 and T3 is each represented by the radar antenna 4 situated at the azimuthal angle φ in which the vehicle to be simulated is situated. Thus, the vehicle T1(t₀) is initially represented by radar antenna S3 at the instant to; the responsibility for representing the vehicle is transferred to the antenna S2 and then to the antenna S1 during the overtaking maneuver and it is transferred to S0 after completion of the overtaking maneuver. Now, the vehicle is drawn with the dashed representation and denoted by T1(t_{E}). Here, the reflection radar signal to be generated transfers step-by-step from radar antenna to radar antenna (indicated by the dotted arrows).

1-18. (canceled)

19. A test bench for testing a distance radar instrument by simulating distance and speed of obstacles, comprising:
a radar emulation device comprising at least one radar antenna and a computer unit with a model of the surroundings, wherein the model of the surroundings comprises data of at least one obstacle with a relative position and speed from the distance radar instrument,
wherein the radar emulation device emits a suitable simulated reflection radar signal on the basis of the relative position and speed predetermined by the model of the surroundings at least partly in the direction of the distance radar instrument in response to a scanning radar signal from the distance radar instrument to enable the distance radar instrument to detect an obstacle with a predetermined relative position and speed,
wherein the radar emulation device extends over an angular range in front of the distance radar instrument such that the obstacle with relative position and speed can be simulated in this angular range with mutually distinguishable angles.

20. The test bench of claim 19, wherein the radar emulation device comprises a positioning system for moving the radar antenna over the angular range such that the obstacle can be simulated with a predetermined relative position and speed in this angular range.

21. The test bench of claim 20, wherein the radar antenna is brought into the position calculated by the model of the surroundings for each obstacle and the relative speed of the obstacle can be represented by the positioning system by the movement of the radar antenna.

22. The test bench of claim 20, wherein the radar antenna is attached to the positioning system in such a way that it does not shadow any further radar antenna on the positioning system.

23. The test bench of claim 22, wherein the radar antennas are each attached at a different level in relation to the movement direction of the positioning system.

24. The test bench of claim 20, wherein the positioning system is designed in such a way that the radar antennas are movably arranged on a common guide contour.

25. The test bench of claim 20, wherein the positioning system is designed in such a way that the radar antennas are in each case movably arranged on separate guide contours.

26. The test bench of claim 20, wherein the positioning system is designed in such a way that the guide contours extend in a straight line, in particular parallel to one another.

27. The test bench of claim 20, wherein the positioning system is designed in such a way that the guide contours extend in concave fashion with an opening toward the distance radar instrument.

28. The test bench of claim 20, wherein the radar emulation device is connected to the distance radar instrument in a closed control loop in such a way that the obstacle can be simulated in real time.

29. The test bench of claim 20, wherein a first radar antenna receives the scanning signal and a second radar antenna subsequently transmits the reflection radar signal.

30. The test bench of claim 20, wherein the radar emulation device is designed in such a way that the scanning radar signal initially passes over at least one deflection mirror for mirroring radar waves prior to being detected by a radar antenna or wherein the reflection radar signal initially passes over at least one deflection mirror for mirroring radar waves prior to being detected by the distance radar instrument.

31. A test bench for testing a distance radar instrument by simulating distance and speed of obstacles, comprising:
a radar emulation device comprising at least one radar antenna and a computer unit with a model of the surroundings, wherein the model of the surroundings comprises data of at least one obstacle with a relative position and speed from the distance radar instrument,
wherein the radar emulation device emits a suitable simulated reflection radar signal on the basis of the relative position and speed predetermined by the model of the surroundings at least partly in the direction of the distance radar instrument in response to a scanning radar signal from the distance radar instrument to enable the distance radar instrument to detect an obstacle with a predetermined relative position and speed,
wherein the radar emulation device extends over an angular range in front of the distance radar instrument such that the obstacle with relative position and speed can be simulated in this angular range with mutually distinguishable angles,
wherein the radar antennas are arranged in such a rotatable manner that they are alignable onto the distance radar instrument in the case of movement.

32. The test bench of claim 31, wherein the radar emulation device comprises a positioning system for moving the radar antenna over the angular range such that the obstacle can be simulated with a predetermined relative position and speed in this angular range.

33. The test bench of claim 32, wherein the radar antenna is attached to the positioning system in such a way that it does not shadow any further radar antenna on the positioning system.

34. The test bench of claim 32, wherein the positioning system is designed in such a way that the radar antennas are movably arranged on a common guide contour.

35. The test bench of claim 32, wherein the positioning system is designed in such a way that the guide contours extend in concave fashion with an opening toward the distance radar instrument.

36. The test bench of claim 32, wherein the radar emulation device is connected to the distance radar instrument in a closed control loop in such a way that the obstacle can be simulated in real time.

37. A test bench for testing a distance radar instrument by simulating distance and speed of obstacles, comprising:
a radar emulation device comprising at least one radar antenna and a computer unit with a model of the surroundings, wherein the model of the surroundings comprises data of at least one obstacle with a relative position and speed from the distance radar instrument,
wherein the radar emulation device emits a suitable simulated reflection radar signal on the basis of the relative position and speed predetermined by the model of the surroundings at least partly in the direction of the distance radar instrument in response to a scanning radar signal from the distance radar instrument to enable the distance radar instrument to detect an obstacle with a predetermined relative position and speed,
wherein the radar emulation device extends over an angular range in front of the distance radar instrument such that the obstacle with relative position and speed can be simulated in this angular range with mutually distinguishable angles,
wherein the model of the surroundings comprises data about the material properties of the obstacle and the reflection radar signal emitted by the radar emulation device in the direction of the distance radar instrument is constituted in such a way that the radar emulation device detects the material properties of the simulated obstacle, in particular by virtue of a predetermined characteristic damping of the reflection radar signal being associated with the material properties of the obstacle to be simulated.

38. The test bench of claim 37, wherein the radar emulation device comprises a positioning system for moving the radar antenna over the angular range such that the obstacle can be simulated with a predetermined relative position and speed in this angular range.

39. The test bench of claim 38, wherein the radar antenna is attached to the positioning system in such a way that it does not shadow any further radar antenna on the positioning system.

40. The test bench of claim 38, wherein the positioning system is designed in such a way that the radar antennas are movably arranged on a common guide contour.

41. The test bench of claim 38, wherein the radar emulation device is connected to the distance radar instrument in a closed control loop in such a way that the obstacle can be simulated in real time.
